(19) United States
(12) Patent Application Publication
(10) Pub. No.: US 2025/0367873 A1
(43) Pub. Date: Dec. 4, 2025

(54) ADDITIVE MANUFACTURING SYSTEM AND METHOD WITH IMPROVED STRUCTURE

(71) Applicant: Evolve Additive Solutions, Inc., Minnetonka, MN (US)

(72) Inventors: Manish Boorugu, Minneapolis, MN (US); Jerry Pickering, Hilton, NY (US); Brian Mullen, Delano, MN (US); Andrew Rice, Chaska, MN (US); J. Samuel Batchelder, Somers, NY (US); Rich Allen, Rochester, NY (US); Zeiter Farah, Minneapolis, MN (US)

(21) Appl. No.: 18/620,263

(22) PCT Filed: Sep. 30, 2022
(86) PCT No.: PCT/US2022/045412

§ 371 Date: Mar. 28, 2024

Related U.S. Application Data
(60) Provisional application No. 63/251,027, filed on Sep. 30, 2021.

(51) Int. Cl. B29C 64/141; B29C 64/188; B29K 55/02; B33Y 10/00; B33Y 40/20; G03G 15/22

(52) U.S. Cl. CPC B29C 64/141; B29C 64/188; B33Y 10/00; B33Y 40/20; G03G 15/224; B29K 2055/02; B29K 2995/0077

(57) ABSTRACT

Embodiments herein relate to 3D printing. In an embodiment, a method for printing an article using a selective toner electrophotographic process (“STEP”) includes successively depositing multiple layers of part material, the layers deposited substantially parallel to a first plane; wherein: a) the multiple areas of part material extend in a perpendicular to the first plane; and b) at least some of the areas of part material are separated from each other to form a gap between the layers of part material; application of heat and pressure to the part material such that a portion of the part material flows into and at least partially fills the gap within the part material.

This application is being filed as a PCT International Patent application on Sep. 30, 2022, in the name of Evolve Additive Solutions, Inc., a U.S. national corporation, applicant for the designation of all countries, and Jerry Pickering, a U.S. Citizen, and Rich Allen, a U.S. Citizen, and Zeiter Farah, a U.S. Citizen, applicants and inventors for the designation of all countries, and Manish Boorugu, a U.S. Citizen, and Brian Mullen, a U.S. Citizen, and J. Samuel Batchelder, a U.S. Citizen, and Andrew Rice, a U.S. Citizen, inventors for the designation of all countries, and claims priority to U.S. Provisional Patent Application No. 63/251,027, filed Sep. 30, 2021, the contents of which are herein incorporated by reference in its entirety.

### FIELD OF THE INVENTION

Embodiments herein relate to methods and systems for forming three-dimensional printed parts, in particular printed parts with an improved structure, including improved structural integrity.

### BACKGROUND

Additive manufacturing systems are used to build 3D parts from digital representations of the parts using one or more additive manufacturing techniques. Examples of commercially available additive manufacturing techniques include extrusion-based techniques, ink jetting, selective laser sintering, powder/binder jetting, electron beam melting, and stereolithographic processes. For each of these techniques, the digital representation of the 3D part is initially digitally sliced into multiple horizontal layers. For each sliced layer, a tool path is then generated, which provides instructions for the particular additive manufacturing system to form the given layer.

One particularly desirable additive manufacturing method is selective toner electrophotographic process (STEP) additive manufacturing, which allows for rapid, high quality production of 3D parts. STEP manufacturing is performed by applying layers of thermoplastic material that are carried from an electrophotography (EP) engine by a transfer medium (e.g., a rotatable belt or drum). The layer is then transferred to a build platform to print the 3D part (or support structure) in a layer-by-layer manner, where the successive layers are transfused together to produce the 3D part (or support structure). The layers are placed down in an X-Y plane, with successive layers positioned on top of one another in a Z-axis perpendicular to the X-Y plane.

A support structure is sometimes built utilizing the same deposition techniques by which the part material is deposited. The supporting layers or structures are often built underneath overhanging portions or in cavities of parts under construction that are not supported by the part material itself. The part material adheres to the support material during fabrication and the support material is subsequently removable from the completed 3D part when the printing process is complete. In typical STEP processes layers of the part material are deposited next to each other in a common X-Y plane. These layers of part are each built on top of one another (layers of part material built on top of other layers of part material; and layers of support material built on to top of other layers of support material) along the Z-axis to create a composite part that contains both part material.

Although STEM deposition can produce very high-quality parts, it is still desirable to form even better parts. For example, in some implementations it is still desirable to have better structural properties, such as improved strength and in particular greater strength, such as improved adhesion between part layers.

### SUMMARY

One generalization described here is to programmably vary the local material deposition density to cause flow within a part or support region to alter the molecular orientation, for example, to increase interlayer part strength. Another generalization is to include varying deposition density and build surface pressurization techniques for structure and flow orientation improvements such as interlayer part strength.

The mechanical properties of polymers depend on the orientation of their molecular chains. For example, the ultimate tensile strength of unoriented polyester is maximally about 8.2 Kpsi, while the strength of pure oriented polyester is maximally about 32 Kpsi. The thermal diffusivity of polymers is roughly 2-3 times higher when oriented than for isotropic material, and 2-3 time lower perpendicular to the orientation direction. The thermal expansion coefficient is reduced, and can even be negative, in the elongation direction. Flake or filamentary fillers tend to orient in the shear directions, generally providing more strength in the shear direction(s) and less in others.

The present application allows for formation of parts that rely on the polymeric chain orientation within the part to achieve the desired function of the part. In the subsequent description, flow is used for relative motion of portions of previously deposited part or support polymer in an additive manufacturing build process.

The present application is directed to a method for printing an article using a selective toner electrophotographic process (STEP). The method includes forming a gap (also referenced as a trench or canyon) between adjacent regions of part material, and then applying pressure and heat to transfer some of the part material into the gap. As the part material flows into the gap it comes together to form an enhanced part that is strong than would otherwise typically be obtained. Part of this enhancement is a result of depositing partial layers of material, referred to herein as enhancement layers, adjacent to the gap. These enhancement layers increase the amount of material (both part and support) adjacent to the gap.

In a first aspect, a method for printing an article using a selective toner electrophotographic process is disclosed, the method including successively depositing multiple layers of part material, the layers deposited substantially parallel to a first plane, wherein: a) the multiple layers of part material extending in a direction perpendicular to the first plane, and b) at least some regions of part material in each layer are separated from each other in the first plane to form a gap between areas of part material within a layer, and application of heat and pressure to the part material such that a portion of the part material flows into and at least partially fills the gap between the part material.

In a second aspect, in addition to one or more of the preceding or following aspects, or in the alternative to some aspects, the first plane includes the X-Y plane.

In a third aspect, in addition to one or more of the preceding or following aspects, or in the alternative to some aspects, wherein at least a portion of the flow vector of the part material within the gap includes a component outside of the first plane.

In a fourth aspect, in addition to one or more of the preceding or following aspects, or in the alternative to some aspects, the aggregate printed part material at the edge of the regions can have a volume substantially equal to the volume of the gap.

In a fifth aspect, in addition to one or more of the preceding or following aspects, or in the alternative to some aspects, an additional gap-filling layer can be deposited on average every second, third, fourth, fifth, sixth, seventh, eighth, ninth, or tenth layer.

In a sixth aspect, in addition to one or more of the preceding or following aspects, or in the alternative to some aspects, further can include deposit of a gap filing layer between at least some of the multiple layers of part material, the gap filling layer can include a layer of part material selectively printed adjacent to the gap of a previous layer.

In a seventh aspect, in addition to one or more of the preceding or following aspects, or in the alternative to some aspects, the average width of the gap can be from 6 to 12 pixels.

In an eighth aspect, in addition to one or more of the preceding or following aspects, or in the alternative to some aspects, the gap can be from 4 to 24 pixels in width.

In a ninth aspect, in addition to one or more of the preceding or following aspects, or in the alternative to some aspects, the average width of the gap can be from 5 to 25 pixels.

In a tenth aspect, in addition to one or more of the preceding or following aspects, or in the alternative to some aspects, further can include reheating, compressing, and recooling the build surface so as to cause the gap to diminish.

In an eleventh aspect, in addition to one or more of the preceding or following aspects, or in the alternative to some aspects, the successive areas of part material can be offset from one another

In a twelfth aspect, in addition to one or more of the preceding or following aspects, or in the alternative to some aspects, the gaps can be uniform.

In a thirteenth aspect, in addition to one or more of the preceding or following aspects, or in the alternative to some aspects, the gaps can be non-uniform.

In a fourteenth aspect, a method for printing an article using a selective toner electrophotographic process, the method can be included, the method including successively depositing multiple layers of part material, the layers deposited substantially parallel to an X-Y plane, wherein: a) multiple layers of part material extend in a Z-direction perpendicular to the X-Y plane, and b) at least some of the layers of part material can be separated from each other in the X-Y plane to form a gap between part material within a layer, application of heat and pressure to the part material such that a portion of the part material flows into and at least partially fills the gap between the part material.

In a fifteenth aspect, in addition to one or more of the preceding or following aspects, or in the alternative to some aspects, wherein at least a portion of the part material flows upward in a Z-direction with a component normal to the X-Y plane within the gap.

In a sixteenth aspect, in addition to one or more of the preceding or following aspects, or in the alternative to some aspects, wherein at least a portion of the part material can have a flow vector component outside of the X-Y plane.

In a seventeenth aspect, in addition to one or more of the preceding or following aspects, or in the alternative to some aspects, the aggregate part material of the gap filling layers can have a volume substantially equal to the volume of the gap.

In an eighteenth aspect, in addition to one or more of the preceding or following aspects, or in the alternative to some aspects, a gap filling layer can be deposited on average every second, third, fourth, fifth, sixth, seventh, eighth, ninth, or tenth layer.

In a nineteenth aspect, in addition to one or more of the preceding or following aspects, or in the alternative to some aspects, the gap filling layer can have an average width of 5 to 15 pixels.

In a twentieth aspect, in addition to one or more of the preceding or following aspects, or in the alternative to some aspects, the average width of the gap between the part regions and support regions can be from 6 to 12 pixels.

In a twenty-first aspect, in addition to one or more of the preceding or following aspects, or in the alternative to some aspects, the gap can be from 6 to 12 pixels in width and the average width of the gap filling layer can be from 10 to 20 pixels in width.

In a twenty-second aspect, in addition to one or more of the preceding or following aspects, or in the alternative to some aspects, the average width of the gap between the part material can be from 5 to 25 pixels.

In a twenty-third aspect, in addition to one or more of the preceding or following aspects, or in the alternative to some aspects, further can include reheating, compressing, and recooling the build surface so as to cause the gap to diminish and the part region surface to become progressively stronger.

In a twenty-fourth aspect, in addition to one or more of the preceding or following aspects, or in the alternative to some aspects, the surface roughness of vertical part surfaces can be less than 8 μm.

In a twenty-fifth aspect, in addition to one or more of the preceding or following aspects, or in the alternative to some aspects, the surface roughness of vertical part surfaces can be less than 4 μm.

In a twenty-sixth aspect, in addition to one or more of the preceding or following aspects, or in the alternative to some aspects, the surface roughness of vertical part surfaces can be less than 2 μm.

In a twenty-seventh aspect, a method for printing an article using a selective toner electrophotographic process, the method can be included, the method including successively depositing multiple layers of part material, the layers deposited substantially parallel to an X-Y plane, wherein: a) the multiple layers of part material extend in a Z-direction perpendicular to the X-Y plane, and b) at least some of the layers of deposited part material can be offset from each other in an X or Y direction to form a gap substantially free of part between the layers of part material and layers of support material, wherein the mass of part material can be higher adjacent to the gap than distant from the gap prior to application of heat and pressure, and application of heat and pressure to the part material such that a portion of the part material flows into and at least partially fills the gap between the part material.

In a twenty-eighth aspect, in addition to one or more of the preceding or following aspects, or in the alternative to some aspects, further can include deposit of a gap filling layer between at least some of the multiple layers of part material, the gap filling layer can include a layer of part material or a layer of support material selectively printed adjacent to the gap.

In a twenty-ninth aspect, in addition to one or more of the preceding or following aspects, or in the alternative to some aspects, a gap filling layer can be deposited every second, third, fourth, fifth, sixth, seventh, eighth, ninth, or tenth layer.

In a thirtieth aspect, in addition to one or more of the preceding or following aspects, or in the alternative to some aspects, the gap filling layer can have an average width of 5 to 15 pixels.

In a thirty-first aspect, in addition to one or more of the preceding or following aspects, or in the alternative to some aspects, the average width of the gap between the part regions and support regions can be from 6 to 12 pixels.

In a thirty-second aspect, in addition to one or more of the preceding or following aspects, or in the alternative to some aspects, the gap can be from 8 to 12 pixels in width and the average width of the gap filling layer can be from 10 to 20 pixels in width.

In a thirty-third aspect, in addition to one or more of the preceding or following aspects, or in the alternative to some aspects, the average width of the gap between the part material can be from 5 to 25 pixels.

In a thirty-fourth aspect, in addition to one or more of the preceding or following aspects, or in the alternative to some aspects, further can include reheating, recompressing, and recooling the build surface so as to cause the gap to diminish and the part region surface to become progressively stronger.

In a thirty-fifth aspect, in addition to one or more of the preceding or following aspects, or in the alternative to some aspects, the surface roughness of vertical part surfaces can be less than 8 μm.

As pressure is applied from the z-axis (or another axis perpendicular to the layers) these enhancement layers function to transfer that pressure down through layers beneath them. The material forming these lower layers (as well as the enhancement layers themselves) are thus under increased pressure, which results in various embodiments a horizontal (x and y direction) flow of material, along with some downward flow of material, into the gap adjacent to the enhancement layers. Once in the gap the material flows upward in the gap. Note that in other implementations the layers are not formed in the same orientation as described above, but the same principals of flow of material into a gap so as to improve structure can be observed.

Thus, in an example embodiment, the enhanced walls of the material along the gap effectively functional like a piston that moves down when rolled by a transfuse roller. Part just outside of the gap is first pressed down. As the tops of the gap sidewalls are pressed down, the material beneath the tops of the trench sidewalls is forced to move sideways into the gap in an undertow. “Undertow” refers to a primarily horizontal flow under the surface as material, also with some downward flow. As material moves out from under the opposing gap walls the part flow into the gap and upward to converge upon one another in the gap. It will be appreciated that in some embodiments the orientation of the layers and gap varies from that described in this example, but similar flow properties and strength improvements are observed. This convergence can occur at the centerline of the gap in some embodiments, such as if the dimensions of the enchantment layers are the same, and the viscosities of the parts are the same. Upon convergence the part moves in the only direction available, which is vertically up the gap because lower portions of the gap are already filled. Generally when the gap is almost filled (the top of the gap is just below the z-axis elevation of the tops of the sidewalls) the flow stops, as the downward pressure over the trench balances the higher downward pressure over the trench sidewalls less the pressure drop from the undertow flow times the viscous flow resistance. It will be appreciated that as described herein the gap is a space between the regions of deposited build material. Multiple layers of build stacked onto one another can form a trench between the layers (the trench essentially multiple gap layers stacked on top of one another). Upon application of transfusion pressure the gap is at least partially (and generally mostly or completely) filled with part flowing into it. Thus the gap (or trench) is filled with material as the layers are deposited and transfusion (described below) occurs.

Thus, in certain embodiments the present application is directed to a method of successively depositing multiple layers of part material, the layers deposited substantially parallel to an X-Y plane (or another plane, referred to herein as a “first plane”). At least some areas or regions of part material are spaced from each other in the X-Y plane (or other plane) to form a gap or trench between the part material areas. The multiple layers of part material extend in a Z-direction perpendicular to the X-Y plane, or another direction perpendicular to first plane). Heat and pressure are applied to the top surface of the aggregated layers of part material such that a portion of the part material flows into and at least partially fills the gap between the areas of part material and make contact with one another. In some cases the gap is not vertical, but rather slanted or inclined (or has another orientation), in which case the part material will flow into that gap, but it may not be normal to the X-Y plane, but rather include a component that is normal to the X-Y plane. The result of this upward (or other direction flow in the case of non-vertical gaps or trenches) flow is that each layer of build material, including material from the gap filling layers, is spread vertically over a Z-axis dimension greater than their thickness prior to application of heat and pressure. This movement of the part material can orient the polymer forming the part material, resulting in a stronger material and part.

In an embodiment, a method for printing an article using a selective toner electrophotographic process is described, the method including successively depositing multiple layers of part material, the layers deposited substantially parallel to an X-Y plane; wherein: a) the multiple layers of part material extend in a Z-direction perpendicular to the X-Y plane; and b) at least some of the layers of part material are offset from each other in the X-Y plane to form a gap between the layers of part material and layers of support material; application of heat and pressure to the part material such that a portion of the part material flows into and at least partially fills the gap between the part material (thereby orienting/lengthening the polymer); and at least a portion of the part material flows in a Z-direction normal to the X-Y plane.

In an embodiment, the printed part material of the gap filling layers has a volume substantially equal to the volume of the gap.

In an embodiment, the gap is from 6 to 12 pixels in width and the average width of the gap filling layer is from 10 to 20 pixels in width.

In an embodiment, the average width of the gap between the areas of part material is from 5 to 25 pixels.

In an embodiment, the part region forms a first perimeter defining a first side of the gap and the support region forms a second perimeter defining a second side of the gap.

In an embodiment, the method further includes reheating and recooling the build surface so as to cause the gap to diminish and the part region surface to become progressively stronger.

### DEFINITIONS

Unless otherwise specified, the following terms as used herein have the meanings provided below:

The term “copolymer” refers to a polymer having two or more monomer species.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

Reference to “a” chemical compound refers one or more molecules of the chemical compound, rather than being limited to a single molecule of the chemical compound. Furthermore, the one or more molecules may or may not be identical, so long as they fall under the category of the chemical compound.

The terms “at least one” and “one or more of” an element are used interchangeably, and have the same meaning that includes a single element and a plurality of the elements, and may also be represented by the suffix “(s)” at the end of the element.

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, the terms “above”, “below”, “top”, “bottom”, and the like are relative to the given axis.

The terms “about” and “substantially” are used herein with respect to measurable values and ranges due to expected variations known to those skilled in the art (e.g., limitations and variabilities in measurements).

The term “providing”, such as for “providing a material” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “selective deposition” refers to an additive manufacturing technique where one or more layers of particles are fused to previously deposited layers utilizing heat and pressure over time where the particles fuse together to form a layer of the part and also fuse to the previously printed layer.

The term “electrostatography” refers to the formation and utilization of latent electrostatic charge patterns to form an image of a layer of a part, a support structure or both on a surface. Electrostatography includes, but is not limited to, electrophotography where optical energy is used to form the latent image, ionography where ions are used to form the latent image and/or electron beam imaging where electrons are used to form the latent image.

The terms “resilient material” and “flowable material” describe distinct materials used in the printing of a 3D part and support. The resilient material has a higher viscosity and/or storage modulus relative to the flowable material.

Unless otherwise specified, pressures referred to herein are based on atmospheric pressure (i.e. one atmosphere).

### BRIEF DESCRIPTION OF THE DRAWINGS

FIG. 1 is a schematic front view of an exemplary electrophotography-based additive manufacturing system for printing 3D parts and support structures from parts, in accordance with embodiments of the present disclosure.

FIG. 2 is a schematic front view of a pair of electrophotography engines of the system for developing layers of the parts, in accordance with embodiments of the present disclosure.

FIG. 3 is a schematic front view of an alternative electrophotography engine, which includes an intermediary drum or belt, in accordance with embodiments of the present disclosure.

FIG. 4 is a schematic front view of a layer transfusion assembly of the system for performing layer transfusion steps with the developed layers, in accordance with embodiments of the present disclosure.

FIG. 5 is a perspective schematic showing an option for deposition of build material in accordance with an implementation herein.

FIG. 6 is a perspective view of multiple layers of deposited build material in accordance with an implementation herein.

FIG. 7 shows plan layouts for three layers of build material.

FIG. 8 shows a top plan view of options for implementation of build material deposition.

FIG. 9 shows a top plan view of an alternative option for implementation of build material deposition.

FIG. 10 shows a schematic of a transfusion roller.

FIG. 11 shows a schematic of a transfusion roller and a rotating platen able to rotate in the x-y plane.

FIG. 12 shows a schematic of a transfusion able to rotate in the y-z plane.

### DETAILED DESCRIPTION

Embodiments of the present disclosure relate to a selective deposition-based additive manufacturing system, such as an electrostatography-based additive manufacturing system, to print 3D parts and/or support structures with high resolution and smooth surfaces. During a printing operation, electrostatographic engines develop or otherwise image each layer of the parts using the electrostatographic process. The developed layers are then transferred to a layer transfusion assembly where they are transfused (e.g., using heat and/or pressure over time) to print one or more 3D parts and support structures in a layer-by-layer manner.

One generalization described here is to programmably vary the local material deposition density to cause flow within a part or support region to alter the molecular orientation, for example, to increase interlayer part strength. Another generalization is to include varying deposition density and build surface pressurization techniques for structure and flow orientation improvements such as interlayer part strength.

The mechanical properties of polymers depend on the orientation of their molecular chains. For example, the ultimate tensile strength of unoriented polyester is maximally about 8.2 Kpsi, while the strength of pure oriented polyester is maximally about 32 Kpsi. The thermal diffusivity of polymers is roughly 2-3 times higher when oriented than for isotropic material, and 2-3 time lower perpendicular to the orientation direction. The thermal expansion coefficient is reduced, and can even be negative, in the elongation direction. Flake or filamentary fillers tend to orient in the shear directions, generally providing more strength in the shear direction(s) and less in others.

The present application allows for formation of parts that rely on the polymeric chain orientation within the part to achieve the desired function of the part. In the subsequent description, flow is used for relative motion of portions of previously deposited part or support polymer in an additive manufacturing build process.

The flows of interest are relative motions over a length scale of microns to centimeters. This application excludes global long-timescale flows such as curl induced by thermal gradients or cross-linking.

Four mechanisms collectively contribute to flows within an additive manufacturing (AM) build. Previous AM processes look to minimize these mechanisms, motivated by the desire to optimize the accuracy of the part-support interfaces: pressure gradients from localized forces, such as a transfuse roller in STEP; compressibility gradients from varying voxel compositions, including partially or fully gas-filled voxels; viscosity gradients produced by composition or temperature variations; motion of relative rigid structures within a less rigid surround, such as buckling of thin vertical walls forcing a recirculation of support around the wall.

Applicant has previously disclosed how the combination of varying voxel compositions and a transfuse roller can smooth vertical surfaces of parts in flow-to-centerline (methods) in the electrophotographic STEP process. See WO 2021/067450 entitled Additive Manufacturing System and Methods with Improved Surface Finish; Batchelder et al., incorporated herein by reference. In brief, a gap or trench of air voxels, typically about 10 42-micron voxels wide, is printed at vertical part-support interfaces. Enhancement voxels on either side of the trench are deposited with more material per area than average for the layer, such that the combined volume of the enhancement regions on either side of a trench corresponds to the missing mass in that trench.

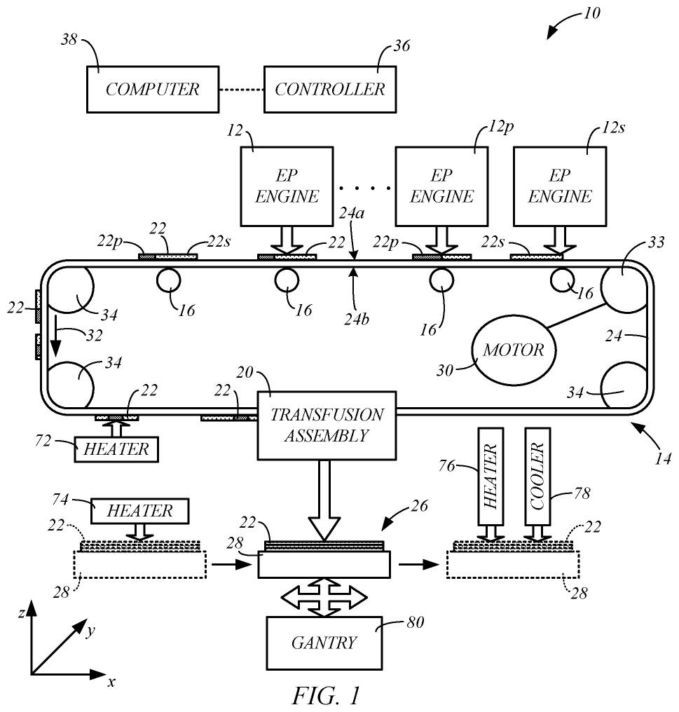

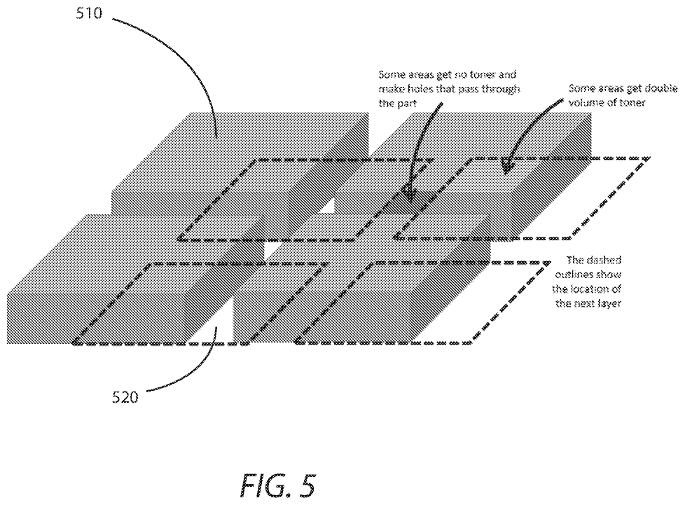

FIGS. 1 to 4 show example components of STEP manufacturing systems, while FIGS. 5 to 12 show further aspects of methods and techniques for producing 3D printed parts with improved strength properties. FIG. 1 is a simplified diagram of an exemplary electrophotography-based additive manufacturing system 10 configured to perform a selective deposition process to printing 3D parts and associated support structures, in accordance with embodiments of the present disclosure. As shown in FIG. 1, system 10 includes one or more EP engines, generally referred to as 12, such as EP engines 12p and 12s, a transfer assembly 14, biasing mechanisms 16, and a transfusion assembly 20. Examples of suitable components and functional operations for system 10 include those disclosed in Hanson et al., U.S. Pat. Nos. 8,879,957 and 8,488,994, and in Comb et al., U.S. Patent Publication Nos. 2013/0186549 and 2013/0186558.

The EP engines 12p and 12s are imaging engines for respectively imaging or otherwise developing layers, generally referred to as 22, of the powder-based parts, where the parts are each preferably engineered for use with the particular architecture of the EP engine 12p or 12s. As discussed below, the developed layers 22 are transferred to a transfer medium (such as belt 24) of the transfer assembly 14, which delivers the layers 22 to the transfusion assembly 20. The transfusion assembly 20 operates to build the 3D part 26, which may include support structures and other features, in a layer-by-layer manner by transfusing the layers 22 together on a build platform 28.

In some embodiments, the transfer medium includes a belt 24, as shown in FIG. 1. Examples of suitable transfer belts for the transfer medium or belt 24 include those disclosed in Comb et al., U.S. Patent Application Publication Nos. 2013/0186549 and 2013/0186558. In some embodiments, the belt 24 includes front surface 24a and rear surface 24b, where front surface 24a faces the EP engines 12, and the rear surface 24b is in contact with the biasing mechanisms 16.

In some embodiments, the transfer assembly 14 includes one or more drive mechanisms that include, for example, a motor 30 and a drive roller 33, or other suitable drive mechanism, and operate to drive the transfer medium or belt 24 in a feed direction 32. In some embodiments, the transfer assembly 14 includes idler rollers 34 that provide support for the belt 24. The example transfer assembly 14 illustrated in FIG. 1 is highly simplified and may take on other configurations. Additionally, the transfer assembly 14 may include additional components that are not shown in order to simplify the illustration, such as, for example, components for maintaining a desired tension in the belt 24, a belt cleaner for removing debris from the surface 24a that receives the layers 22, and other components.

The EP engine 12s develops layer or image portions 22s of powder-based support material, and the EP engine 12p develops layer or image portions 22p of powder-based part/build material. In some embodiments, the EP engine 12s is positioned upstream from the EP engine 12p relative to the feed direction 32, as shown in FIG. 1. In alternative embodiments, the arrangement of the EP engines 12p and 12s may be reversed such that the EP engine 12p is upstream from the EP engine 12s relative to the feed direction 32. In further alternative embodiments, system 10 may include three or more EP engines 12 for printing layers of additional materials, as indicated in FIG. 1.

Example system 10 also includes controller 36, which represents one or more processors that are configured to execute instructions, which may be stored locally in memory of the system 10 or in memory that is remote to the system 10, to control components of the system 10 to perform one or more functions described herein. In some embodiments, the controller 36 includes one or more control circuits, microprocessor-based engine control systems, and/or digitally-controlled raster imaging processor systems, and is configured to operate the components of system 10 in a synchronized manner based on printing instructions received from a host computer 38 or a remote location.

In some embodiments, the host computer 38 includes one or more computer-based systems that are configured to communicate with controller 36 to provide the print instructions (and other operating information). For example, the host computer 38 may transfer information to the controller 36 that relates to the sliced layers of the 3D parts and support structures, thereby allowing the system 10 to print the 3D parts 26 and support structures in a layer-by-layer manner. The controller 36 may also use signals from one or more sensors to assist in properly registering the printing of the part or image portion 22p and/or the support structure or image portion 22s with a previously printed corresponding support structure portion 22s or part portion 22p on the belt 24 to form the individual layers 22.

The components of system 10 may be retained by one or more frame structures (not shown for simplicity). Additionally, the components of system 10 may be retained within an enclosable housing (not shown for simplicity) that prevents components of the system 10 from being exposed to ambient light during operation.

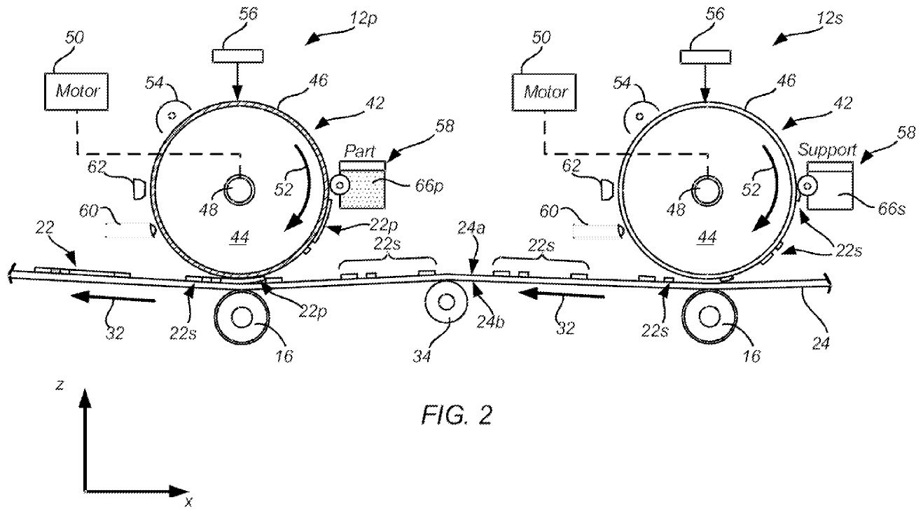

FIG. 2 is a schematic front view of the EP engines 12p and 12s of the system 10, in accordance with example embodiments of the present disclosure. In the illustrated embodiment, the EP engines 12p and 12s may include the same components, such as a photoconductor drum 42 having a conductive drum body 44 and a photoconductive surface 46. The conductive drum body 44 is an electrically-conductive drum (e.g., fabricated from copper, aluminum, tin, or the like) that is electrically grounded and configured to rotate around a shaft 48. The shaft 48 is correspondingly connected to a drive motor 50, which is configured to rotate the shaft 48 (and the photoconductor drum 42) in the direction of arrow 52 at a constant rate.

The photoconductive surface 46 can be a thin film extending around the circumferential surface of the conductive drum body 44, and is preferably derived from one or more photoconductive materials, such as amorphous silicon, selenium, zinc oxide, organic materials, and the like. As discussed below, the surface 46 is configured to receive latent-charged images of the sliced layers of a 3D part or support structure (or negative images), and to attract charged particles of the part to the charged or discharged image areas, thereby creating the layers of the 3D part or support structure.

As further shown, each of the example EP engines 12p and 12s also includes a charge inducer 54, an imager 56, a development station 58, a cleaning station 60, and a discharge device 62, each of which may be in signal communication with the controller 36. The charge inducer 54, the imager 56, the development station 58, the cleaning station 60, and the discharge device 62 accordingly define an image-forming assembly for the surface 46 while the drive motor 50 and the shaft 48 rotate the photoconductor drum 42 in the direction 52.

Each of the EP engines 12 uses the powder-based material (e.g., polymeric or thermoplastic toner), generally referred to herein by reference character 66, to develop or form the layers 22. In some embodiments, the image-forming assembly for the surface 46 of the EP engine 12s is used to form support layers 22s (e.g., image portions) of powder-based support material 66s, where a supply of the support material 66s may be retained by the development station 58 (of the EP engine 12s) along with carrier particles. Similarly, the image-forming assembly for the surface 46 of the EP engine 12p is used to form part layers 22p (e.g., image portion) of powder-based part material 66p, where a supply of the part material 66p may be retained by the development station 58 (of the EP engine 12p) along with carrier particles. Additional EP engines 12 may be included that utilize other support or part materials 66.

The charge inducer 54 is configured to generate a uniform electrostatic charge on the surface 46 as the surface 46 rotates in the direction 52 past the charge inducer 54. Suitable devices for the charge inducer 54 include corotrons, scorotrons, charging rollers, and other electrostatic charging devices.

Each imager 56 is a digitally-controlled, pixel-wise light exposure apparatus configured to selectively emit electromagnetic radiation toward the uniform electrostatic charge on the surface 46 as the surface 46 rotates in the direction 52 the past imager 56. The selective exposure of the electromagnetic radiation to the surface 46 is directed by the controller 36, and causes discrete pixel-wise locations of the electrostatic charge to be removed (i.e., discharged to ground), thereby forming latent image charge patterns on the surface 46.

Suitable devices for the imager 56 include scanning laser (e.g., gas or solid-state lasers) light sources, light emitting diode (LED) array exposure devices, and other exposure device conventionally used in 2D electrophotography systems. In alternative embodiments, suitable devices for the charge inducer 54 and the imager 56 include ion-deposition systems configured to selectively directly deposit charged ions or electrons to the surface 46 to form the latent image charge pattern.

Each development station 58 is an electrostatic and magnetic development station or cartridge that retains the supply of the part material 66p or the support material 66s, along with carrier particles. The development stations 58 may function in a similar manner to single or dual component development systems and toner cartridges used in 2D electrophotography systems. For example, each development station 58 may include an enclosure for retaining the part material 66p or the support material 66s and carrier particles. When agitated, the carrier particles generate triboelectric charges to attract the powders of the part material 66p or the support material 66s, which charges the attracted powders to a desired sign and magnitude, as discussed below.

Each development station 58 may also include one or more devices for transferring the charged part or the support material 66p or 66s to the surface 46, such as conveyors, fur brushes, paddle wheels, rollers, and/or magnetic brushes. For instance, as the surface 46 (containing the latent charged image) rotates from the imager 56 to the development station 58 in the direction 52, the charged part material 66p or the support material 66s is attracted to the appropriately charged regions of the latent image on the surface 46, utilizing either charged area development or discharged area development (depending on the electrophotography mode being utilized). This creates successive layers 22p or 22s as the photoconductor drum continues to rotate in the direction 52, where the successive layers 22p or 22s correspond to the successive sliced layers of the digital representation of the 3D part or support structure.

The successive layers 22p or 22s are then rotated with the surface 46 in the direction 52 to a transfer region in which layers 22p or 22s are successively transferred from the photoconductor drum 42 to the belt 24 or other transfer medium, as discussed below. While illustrated as a direct engagement between the photoconductor drum 42 and the belt 24, in some preferred embodiments, the EP engines 12p and 12s may also include intermediary transfer drums and/or belts, as discussed further below.

After a given layer 22p or 22s is transferred from the photoconductor drum 42 to the belt 24 (or an intermediary transfer drum or belt), the drive motor 50 and the shaft 48 continue to rotate the photoconductor drum 42 in the direction 52 such that the region of the surface 46 that previously held the layer 22p or 22s passes the cleaning station 60. The cleaning station 60 is a station configured to remove any residual, non-transferred portions of part 66p or 66s. Suitable devices for the cleaning station 60 include blade cleaners, brush cleaners, electrostatic cleaners, vacuum-based cleaners, and combinations thereof.

After passing the cleaning station 60, the surface 46 continues to rotate in the direction 52 such that the cleaned regions of the surface 46 pass the discharge device 62 to remove any residual electrostatic charge on the surface 46, prior to starting the next cycle. Suitable devices for the discharge device 62 include optical systems, high-voltage alternating-current corotrons and/or scorotrons, one or more rotating dielectric rollers having conductive cores with applied high-voltage alternating-current, and combinations thereof.

The biasing mechanisms 16 are configured to induce electrical potentials through the belt 24 to electrostatically attract the layers 22p and 22s from the EP engines 12p and 12s to the belt 24. Because the layers 22p and 22s are each only a single layer increment in thickness at this point in the process, electrostatic attraction is suitable for transferring the layers 22p and 22s from the EP engines 12p and 12s to the belt 24.

The controller 36 preferably rotates the photoconductor drums of the EP engines 12p and 12s at the same rotational rates that are synchronized with the line speed of the belt 24 and/or with any intermediary transfer drums or belts. This allows the system 10 to develop and transfer the layers 22p and 22s in coordination with each other from separate developer images. In particular, as shown, each part layer 22p may be transferred to the belt 24 with proper registration with each support layer 22s to produce a combined part layer or combined image layer, which is generally designated as layer 22. As can be appreciated, some of the layers 22 transferred to the layer transfusion assembly 20 may only include support material 66s or may only include part material 66p, depending on the particular support structure and 3D part geometries and layer slicing.

In an alternative embodiment, the part layers 22p and the support layers 22s may optionally be developed and transferred along the belt 24 separately, such as with alternating layers 22p and 22s. These successive, alternating layers 22p and 22s may then be transferred to layer transfusion assembly 20, where they may be transfused separately to form the layer 22 and print or build the 3D part 26 and support structure.

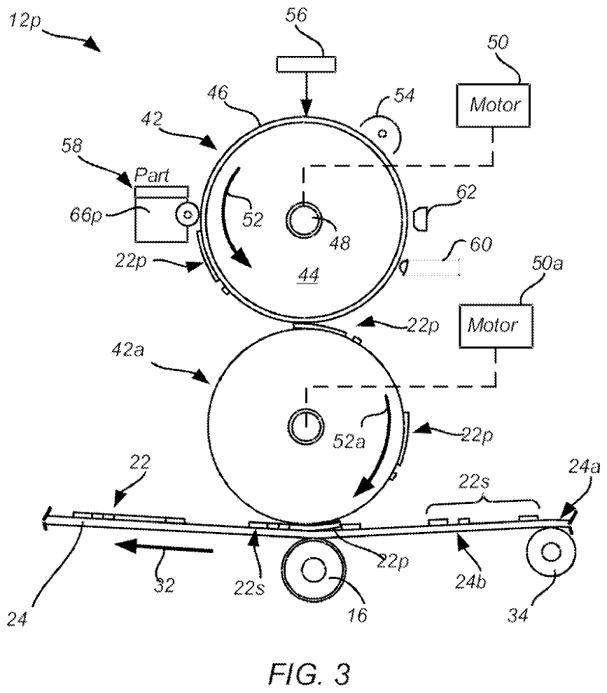

In a further alternative embodiment, one or both of the EP engines 12p and 12s may also include one or more intermediary transfer drums and/or belts between the photoconductor drum 42 and the belt or transfer medium or belt 24. For example, as shown in FIG. 3, the EP engine 12p may also include an intermediary drum 42a that rotates in the direction 52a that opposes the direction 52, in which drum 42 is rotated, under the rotational power of motor 50a. The intermediary drum 42a engages with the photoconductor drum 42 to receive the developed layers 22p from the photoconductor drum 42, and then carries the received developed layers 22p and transfers them to the belt 24.

The EP engine 12s may include the same arrangement of an intermediary drum 42a for carrying the developed layers 22s from the photoconductor drum 42 to the belt 24. The use of such intermediary transfer drums or belts for the EP engines 12p and 12s can be beneficial for thermally isolating the photoconductor drum 42 from the belt 24, if desired.

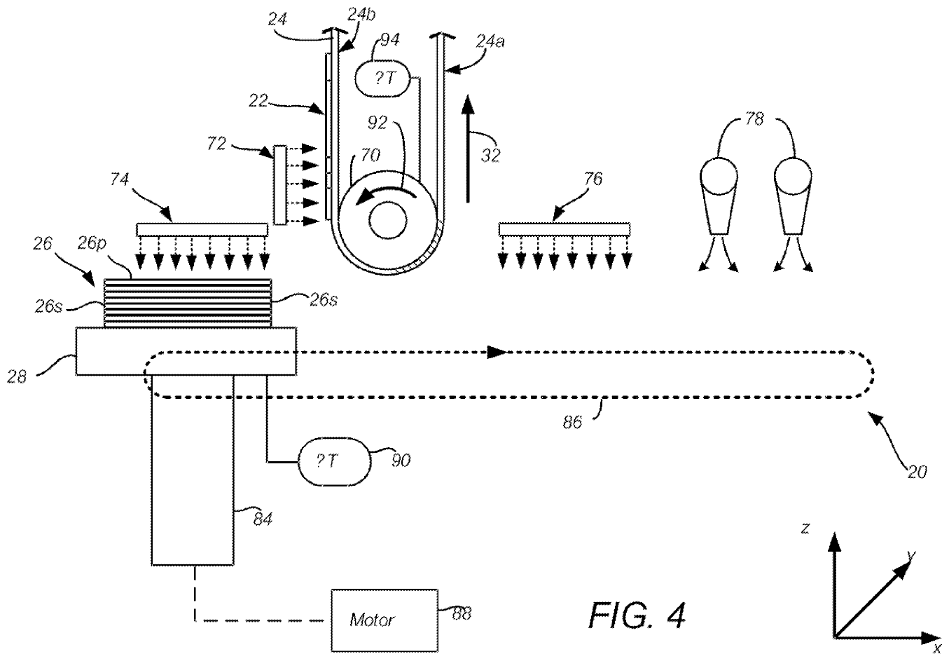

FIG. 4 illustrates an embodiment of the layer transfusion assembly 20. As shown, the exemplary transfusion assembly 20 includes the build platform 28, a nip roller 70, and pre-transfusion heaters 72 and 74. In some embodiments, the transfusion assembly includes, an optional post-transfusion heater 76, and/or a cooler (e.g., air jets 78 or other cooling units), as shown in FIGS. 1 and 4. The build platform 28 is a platform assembly or platen of system 10 that is configured to receive the heated combined layers 22 (or separate layers 22p and 22s) for printing the part 26, which includes a 3D part 26p formed of the part layers 22p, and support structure 26s formed of the support layers 22s, in a layer-by-layer manner. In some embodiments, the build platform 28 may include removable film substrates (not shown) for receiving the printed layers 22, where the removable film substrates may be restrained against build platform using any suitable technique (e.g., vacuum drawing).

The build platform 28 is supported by a gantry 84 or other suitable mechanism, which can be configured to move the build platform 28 along the z-axis and the x-axis (and, optionally, also the y-axis), as illustrated schematically in FIG. 1 (the y-axis being into and out of the page in FIG. 1, with the z-, x- and y-axes being mutually orthogonal, following the right-hand rule). The layers are put down generally parallel to an x-y plane, and the layers stack on top of one another along the z-axis. The gantry 84 may produce cyclical movement patterns relative to the nip roller 70 and other components, as illustrated by broken line 86 in FIG. 4. The particular movement pattern of the gantry 84 can follow essentially any desired path suitable for a given application. The gantry 84 may be operated by a motor 88 based on commands from the controller 36, where the motor 88 may be an electrical motor, a hydraulic system, a pneumatic system, or the like. In one embodiment, the gantry 84 can included an integrated mechanism that precisely controls movement of the build platform 28 in the z- and x-axis directions (and optionally the y-axis direction). In alternate embodiments, the gantry 84 can include multiple, operatively-coupled mechanisms that each control movement of the build platform 28 in one or more directions, for instance, with a first mechanism that produces movement along both the z-axis and the x-axis and a second mechanism that produces movement along only the y-axis. The use of multiple mechanisms can allow the gantry 84 to have different movement resolution along different axes. Moreover, the use of multiple mechanisms can allow an additional mechanism to be added to an existing mechanism operable along fewer than three axes.

In the illustrated embodiment, the build platform 28 can be heatable with heating element 90 (e.g., an electric heater). The heating element 90 is configured to heat and maintain the build platform 28 at an elevated temperature that is greater than room temperature (25° C.), such as at a desired average part temperature of 3D part 26p and/or support structure 26s, as discussed in Comb et al., U.S. Patent Application Publication Nos. 2013/0186549 and 2013/0186558. This allows the build platform 28 to assist in maintaining 3D part 26p and/or support structure 26s at this average part temperature.

The nip roller 70 is an example heatable element or heatable layer transfusion element, which is configured to rotate around a fixed axis with the movement of the belt 24. In particular, the nip roller 70 may roll against the rear surface 22s in the direction of arrow 92 while the belt 24 rotates in the feed direction 32. In the shown embodiment, the nip roller 70 is heatable with a heating element 94 (e.g., an electric heater). The heating element 94 is configured to heat and maintain nip roller 70 at an elevated temperature that is greater than room temperature (25° C.), such as at a desired transfer temperature for the layers 22.

The pre-transfusion heater 72 includes one or more heating devices (e.g., an infrared heater and/or a heated air jet) that are configured to heat the layers 22 on the belt 24 to a selected temperature of the layer 22, such as up to a fusion temperature of the part material 66p and the support material 66s, prior to reaching nip roller 70. Each layer 22 desirably passes by (or through) the heater 72 for a sufficient residence time to heat the layer 22 to the intended transfer temperature. The pre-transfusion heater 74 may function in the same manner as the heater 72, and heats the top surfaces of the 3D part 26p and support structure 26s on the build platform 28 to an elevated temperature, and in one embodiment to supply heat to the layer upon contact.

The parts 66p and 66s of the layers 22p and 22s may be heated together with the heater 72 to substantially the same temperature, and the parts 66p and 66s at the top surfaces of the 3D part 26p and support structure 26s may be heated together with heater 74 to substantially the same temperature. This allows the part layers 22p and the support layers 22s to be transfused together to the top surfaces of the 3D part 26p and the support structure 26s in a single transfusion step as the combined layer 22. As discussed below, a gap can be placed between the support layers 22s and part layers 22p, and under heat and pressure part are pressed together in a manner such as to produce an improved interface with reduced surface roughness.

An optional post-transfusion heater 76 may be provided downstream from nip roller 70 and upstream from air jets 78, and configured to heat the transfused layers 22 to an elevated temperature in a single post-fuse step.

As mentioned above, in some embodiments, prior to building the part 26 on the build platform 28, the build platform 28 and the nip roller 70 may be heated to their selected temperatures. For example, the build platform 28 may be heated to the average part temperature (e.g., bulk temperature) of 3D part 26p and support structure 26s. In comparison, the nip roller 70 may be heated to a desired transfer temperature or nip entrance temperature for the layers 22.

As further shown in FIG. 4, during operation, the gantry 84 may move the build platform 28 (with 3D part 26p and support structure 26s) in a reciprocating pattern 86. In particular, the gantry 84 may move the build platform 28 along the x-axis below, along, or through the heater 74. The heater 74 heats the top surfaces of 3D part 26p and support structure 26s to an elevated temperature, such as the transfer temperatures of the parts. As discussed in Comb et al., U.S. Patent Application Publication Nos. 2013/0186549 and 2013/0186558, the heaters 72 and 74 may heat the layers 22 and the top surfaces of 3D part 26p and support structure 26s to about the same temperatures to provide a consistent transfusion interface temperature. Alternatively, the heaters 72 and 74 may heat layers 22 and the top surfaces of 3D part 26p and support structure 26s to different temperatures to attain a desired transfusion interface temperature.

The continued rotation of the belt 24 and the movement of the build platform 28 align or register the heated layer 22 (e.g., combined image layer) with the heated top surfaces of 3D part 26p and support structure 26s with proper registration along the x-axis. The gantry 84 may continue to move the build platform 28 along the x-axis, at a rate that is synchronized with the rotational rate of the belt 24 in the feed direction 32 (i.e., the same directions and speed). This causes the rear surface 24b of the belt 24 to rotate around the nip roller 70 to nip the belt 24 and the heated layer 22 against the top surfaces of 3D part 26p and support structure 26s. This presses the heated layer 22 between the heated top surfaces of 3D part 26p and support structure 26s at the location of the nip roller 70, which at least partially transfuses the heated layer 22 to the top layers of 3D part 26p and support structure 26s.

As the transfused layer 22 passes the nip of the nip roller 70, the belt 24 wraps around the nip roller 70 to separate and disengage from the build platform 28. This assists in releasing the transfused layer 22 from the belt 24, allowing the transfused layer 22 to remain adhered to 3D part 26p and support structure 26s. Maintaining the transfusion interface temperature at a transfer temperature that is higher than its glass transition temperature, but lower than its fusion temperature, allows the heated layer 22 to be hot enough to adhere to the 3D part 26p and support structure 26s, while also being cool enough to readily release from the belt 24. Additionally, the close melt rheologies of the parts allow them to be transfused in the same step. The temperature and pressures can be selected, as is discussed below, to promote flow of part material into a gap between the two materials. Often the rheologies are preferably close, they can be transfused with glass transition temperatures that are significantly different from one another in some constructions. This flow into the gap, typically accompanied by an upward movement of the part, results in a stronger interface between the part and support, plus a stronger surface for the part after removal of the support.

After release, the gantry 84 continues to move the build platform 28 along the x-axis to the post-transfusion heater 76. At optional post-transfusion heater 76, the top-most layers of 3D part 26p and the support structure 26s (including the transfused layer 22) may then be heated to at least the fusion temperature of the thermoplastic-based powder in a post-fuse or heat-setting step. This optionally heats the material of the transfused layer 22 to a highly fusable state such that polymer molecules of the transfused layer 22 quickly interdiffuse (also referred to as reptate) to achieve a high level of interfacial entanglement with 3D part 26p and support structure 26s.

Additionally, as the gantry 84 continues to move the build platform 28 along the x-axis past the post-transfusion heater 76 to the air jets 78, the air jets 78 blow cooling air towards the top layers of 3D part 26p and support structure 26s. This actively cools the transfused layer 22 down to the average part temperature, as discussed in Comb et al., U.S. Patent Application Publication Nos. 2013/0186549 and 2013/0186558.

To assist in keeping the 3D part 26p and support structure 26s at the average part temperature, in some embodiments, the heater 74 and/or the heater 76 may operate to heat only the top-most layers of 3D part 26p and support structure 26s. For example, in embodiments in which heaters 72, 74, and 76 are configured to emit infrared radiation, the 3D part 26p and support structure 26s may include heat absorbers and/or other colorants configured to restrict penetration of the infrared wavelengths to within the top-most layers. Alternatively, the heaters 72, 74, and 76 may be configured to blow heated air across the top surfaces of 3D part 26p and support structure 26s. In either case, limiting the thermal penetration into 3D part 26p and support structure 26s allows the top-most layers to be sufficiently transfused, while also reducing the amount of cooling required to keep 3D part 26p and support structure 26s at the average part temperature. However generally sufficient thermal penetration is desired to promote flow of part material into gaps positioned at the interface between the part.

The gantry 84 may then actuate the build platform 28 downward, and move the build platform 28 back along the x-axis to a starting position along the x-axis, following the reciprocating rectangular pattern 86. The build platform 28 desirably reaches the starting position for proper registration with the next layer 22. In some embodiments, the gantry 84 may also actuate the build platform 28 and 3D part 26p/support structure 26s upward for proper registration with the next layer 22. The same process may then be repeated for each remaining layer 22 of 3D part 26p and support structure 26s.

After the transfusion operation is completed, the resulting 3D part 26p and support structure 26s may be removed from system 10 and undergo one or more post-printing operations. For example, support structure 26s may be sacrificially removed from 3D part 26p using an aqueous-based solution, such as an aqueous alkali solution. Under this technique, support structure 26s may at least partially dissolve in the solution, separating it from 3D part 26p in a hands-free manner.

FIG. 5 is a perspective schematic showing an option for deposition of build material in accordance with an implementation herein. The build material 510 is laid down with gaps 520. During the transfusion process these gaps 520 are filled with build material, thereby orienting polymers (or other material) to provide a stronger part.

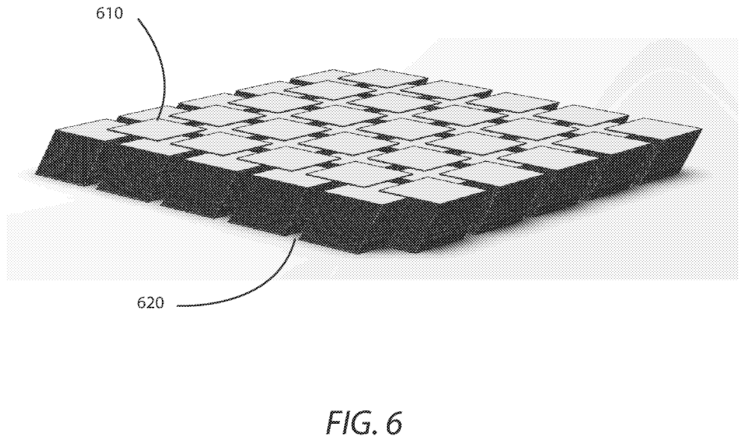

FIG. 6 is a perspective view of layers of deposited build material 610 in accordance with an implementation herein, showing gaps 620. These gaps 620 are filled as transfusion occurs, generally the gaps will have disappeared near the bottom of the part but will be open near the top of the part during construction (but entirely closed on the finished part). The gaps 620 can intentionally be reduced near the top of the part during production.

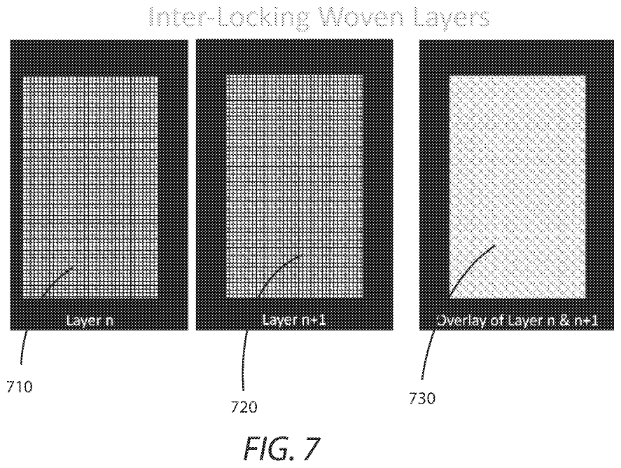

FIG. 7 shows plan layouts for three layers of build material, showing a first pattern 710, a second pattern 720, and a combined pattern 730. It will be understood that the first pattern 710 and second pattern 720 can be over printed as sequential layers that when transfused create full coverage 730 (or at least desired coverage)

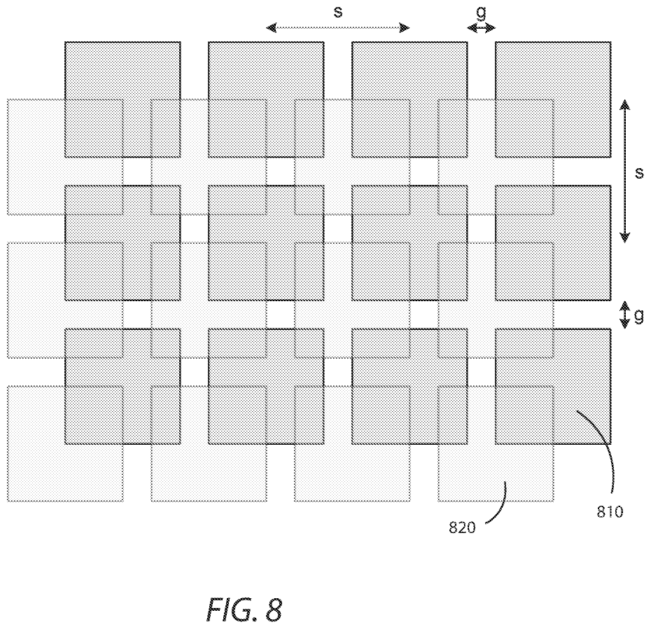

FIG. 8 shows a top plan view of options for implementation of build material deposition, showing first layer with areas 810 of build material and second layer with areas 820 of build material.

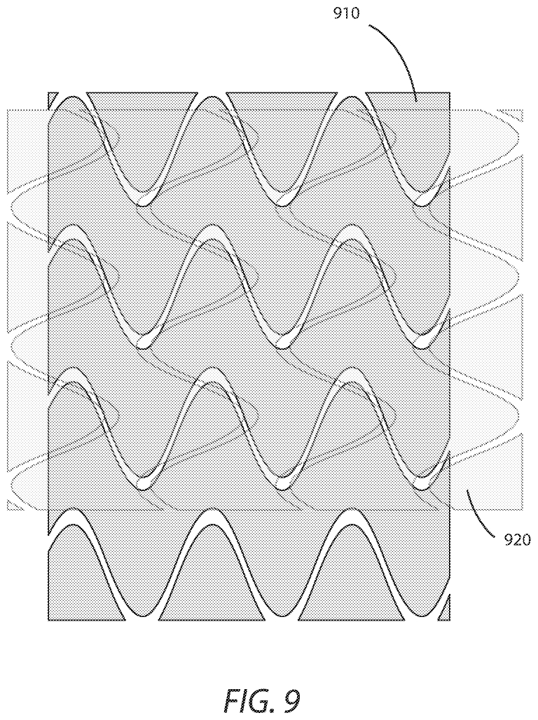

FIG. 9 shows a top plan view of an alternative option for implementation of build material deposition. In an example, a repeated two-layer sequence in which a square cartesian grid of posts are spaced on centers s apart. The gaps between the posts are g wide, making an array of square posts s-g on a side. The void fraction of each image is (1−g/s)\hat{ }2. In the example shown, g/s˜0.2, so the solid fraction is about 64%. The grid pattern is translated by s/2 in x and y for each subsequent layer. In particular, no image deposits material on a lattice of g-by-g square holes located at (n*s,m*s) and ((n+0.5)*s,(m+0.5)*s), where n and m are integers.

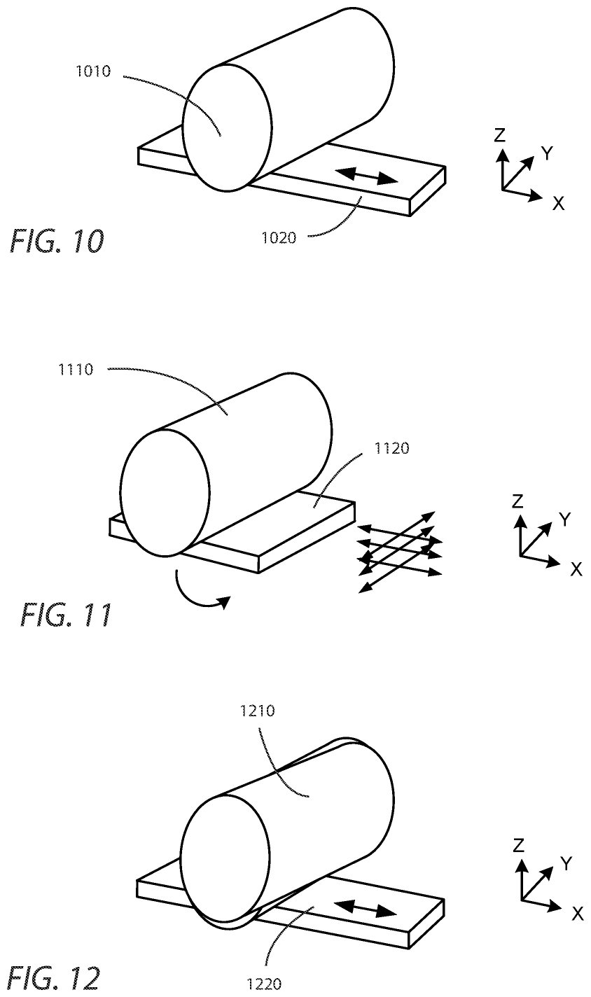

FIG. 10 shows a schematic of a transfusion roller 1010 and a platen 1020. In an example embodiment the relative movement of the roller 1010 and platen 1020 can be adjusted so as to add sheer to the surface of a part being produced on the platen, thereby providing orientation of the part polymer and increasing strength of the part.

FIG. 11 shows a schematic of a transfusion roller 1110 and a rotating platen 1120 able to rotate in the x-y plane. The platen 1120 can be rotated between transfusion steps to provide alternating sheer force (at, for example 90 degree angles between layers) to orient the fibers, optionally with alternating orientation so as to provide a strengthen part

FIG. 12 shows a schematic of a transfusion roller 1210 able to rotate in the y-z plane relative to the platen 1220, thereby again adding sheer force to orient polymer and strengthen the part.

The following examples illustrate various aspects of the subject matter disclosed herein:

### Example: Improving Z Part Strength

A slab of ABS part material ABS was printed without support in alternating layers of Manhattan trench arrays, resulting in (before accounting for flow) a dense array of vertical air columns with local surroundings of enhanced material density. During transfuse, the denser regions are impelled to flow up into the air channels by the transfuse roller, creating an array of connective columns of z-oriented polymer. As a result, the impact strength in the z direction almost doubles compared to a uniform material deposited without deliberate z flow.

This differs from previously disclosed methods in that shear flow is confined to a single material; shear flow in Z is being fed by all X-Y orientations, not just two; and the result is fracture strength improvement, rather than structure improvement.

### Example: Altering the Flow Channel Width in the XY Bitslice to Maintain Flow Channel Width in Non-Vertical Flow

One alternative for use with non-vertical surfaces is to adjust the trench and enhancement offset distances with the local surface tilt angle.

### Example: Leave Nearly Horizontal Surfaces Alone

A further alternative for non-vertical surfaces is that nearly horizontal surface should not be modified. STEP horizontal surfaces are conspicuously smooth and flat, and up to a few degrees the z aliasing is not apparent.

### Example: Adjust for Part and Support Relative Viscosity

Part and support that are matched for viscosity will equally fill the trench, however High viscosity part coupled with low viscosity support or vice versa will cause un-equal filling and the need to adjust the trench half-widths and corresponding material enhancement layers to account for the un-equal filling. While it may be desirable to always match the material viscosities, this may not be possible do to limited available material viscosity ranges or in multi-material printing, part materials with multiple viscosities being paired with a single support having one viscosity.

### Example: Employing Several Support Viscosities to Optimize A Multi-Material Part

In a multi-material part having part material with different viscosities, the methodsL can be optimized at the local part interface dependent on the particular part material at that location by placing a matching (or more closely matching) support material. In a 4 engine STEP process with 2 part materials, 2 support materials can be employed where the support material are equally applied away from the part interface, but at the part surface only the more closely matching support is applied.

### Example: When Insufficient Enhancement Area is Available, Shrink the Trench

For thin walls, thin channels, corners, posts, or other deviations of the boundary from a straight line, there are instances where the area required to store the enhancement material is not available, either because the part features are thin, or because the flow from that enhancement area is two-dimensional. In these cases, the trenches being filled by these conflicted enhancement regions should be narrowed so that the enhancement areas and void areas remain consistent.

Although the present disclosure has been described with reference to preferred embodiments, workers skilled in the art will recognize that changes may be made in form and detail without departing from the spirit and scope of the disclosure.

What is claimed is:

1. A method for printing an article using a selective toner electrophotographic process, the method comprising:
successively depositing multiple layers of part material, the layers deposited substantially parallel to a first plane; wherein:
a) the multiple layers of part material extending in a direction perpendicular to the first plane; and
b) at least some regions of part material being separated from each other in the first plane to form a gap between areas of part material within a layer; and
application of heat and pressure to the part material such that a portion of the part material flows into and at least partially fills the gap between the part material.

2. The method of any of claims 1 and 3-13, wherein the first plane comprises the X-Y plane.

3. The method of any of claims 1-2 and 4-13, wherein at least a portion of the flow vector of the part material within the gap includes a component outside of the first plane.

4. The method of any of claims 1-3 and 5-13, wherein the aggregate printed part material at the edge of the regions has a volume substantially equal to the volume of the gap.

5. The method of any of claims 1-4 and 6-13, wherein an additional gap-filling layer is deposited on average every second, third, fourth, fifth, sixth, seventh, eighth, ninth, or tenth layer.

6. The method of any of claims 1-5 and 7-13, further comprising deposit of a gap filing layer between at least some of the multiple layers of part material; the gap filling layer comprising a layer of part material selectively printed adjacent to the gap of a previous layer.

7. The method of any of claims 1-6 and 8-13, wherein the average width of the gap is from 6 to 12 pixels.

8. The method of any of claims 1-7 and 9-13, wherein the gap is from 4 to 24 pixels in width.

9. The method of any of claims 1-8 and 10-13, wherein the average width of the gap is from 5 to 25 pixels.

10. The method of any of claims 1-9 and 11-13, further comprising reheating, compressing, and recooling the build surface so as to cause the gap to diminish.

11. The method of any of claims 1-10 and 12-13, wherein the successive areas of part material are offset from one another

12. The method of any of claims 1-11 and 13, wherein the gaps are uniform.

13. The method of any of claims 1-12, wherein the gaps are non-uniform.

14. A method for printing an article using a selective toner electrophotographic process, the method comprising:
successively depositing multiple layers of part material, the layers deposited substantially parallel to an X-Y plane; wherein:
a) multiple layers of part material extend in a Z-direction perpendicular to the X-Y plane; and
b) at least some of the layers of part material are separated from each other in the X-Y plane to form a gap between part material within a layer;
application of heat and pressure to the part material such that a portion of the part material flows into and at least partially fills the gap between the part material.

15. The method of any of claims 14 and 16-26, wherein at least a portion of the part material flows upward in a Z-direction with a component normal to the X-Y plane within the gap.

16. The method of any of claims 14-15 and 17-26, wherein at least a portion of the part material has a flow vector component outside of the X-Y plane.

17. The method of any of claims 14-16 and 18-26, wherein the aggregate part material of the gap filling layers has a volume substantially equal to the volume of the gap.

18. The method of any of claims 14-17 and 19-26, wherein a gap filling layer is deposited on average every second, third, fourth, fifth, sixth, seventh, eighth, ninth, or tenth layer.

19. The method of any of claims 14-18 and 20-26, wherein the gap filling layer has an average width of 5 to 15 pixels.

20. The method of any of claims 14-19 and 21-26, wherein the average width of the gap between the part regions and support regions is from 6 to 12 pixels.

21. The method of any of claims 14-20 and 22-26, wherein the gap is from 6 to 12 pixels in width and the average width of the gap filling layer is from 10 to 20 pixels in width.

22. The method of any of claims 14-21 and 23-26, wherein the average width of the gap between the part material is from 5 to 25 pixels.

23. The method of any of claims 14-22 and 24-26, further comprising reheating, compressing, and recooling the build surface so as to cause the gap to diminish and the part region surface to become progressively stronger.

24. The method of any of claims 14-23 and 25-26, wherein the surface roughness of vertical part surfaces is less than 8 μm.

25. The method of any of claims 14-24 and 26, wherein the surface roughness of vertical part surfaces is less than 4 μm.

26. The method of any of claims 14-25, wherein the surface roughness of vertical part surfaces is less than 2 μm.

27. A method for printing an article using a selective toner electrophotographic process, the method comprising:
successively depositing multiple layers of part material, the layers deposited substantially parallel to an X-Y plane; wherein:
a) the multiple layers of part material extend in a Z-direction perpendicular to the X-Y plane; and
b) at least some of the layers of deposited part material are offset from each other in an X or Y direction to form a gap substantially free of part between the layers of part material and layers of support material, wherein the mass of part material is higher adjacent to the gap than distant from the gap prior to application of heat and pressure; and
application of heat and pressure to the part material such that a portion of the part material flows into and at least partially fills the gap between the part material.

28. The method of any of claims 27 and 29-35, further comprising deposit of a gap filling layer between at least some of the multiple layers of part material; the gap filling layer comprising a layer of part material or a layer of support material selectively printed adjacent to the gap.

29. The method of any of claims 27-28 and 30-35, wherein a gap filling layer is deposited every second, third, fourth, fifth, sixth, seventh, eighth, ninth, or tenth layer.

30. The method of any of claims 27-29 and 31-35, wherein the gap filling layer has an average width of 5 to 15 pixels.

31. The method of any of claims 27-30 and 32-35, wherein the average width of the gap between the part regions and support regions is from 6 to 12 pixels.

32. The method of any of claims 27-31 and 33-35, wherein the gap is from 8 to 12 pixels in width and the average width of the gap filling layer is from 10 to 20 pixels in width.

33. The method of any of claims 27-32 and 34-35, wherein the average width of the gap between the part material is from 5 to 25 pixels.

34. The method of any of claims 27-33 and 35, further comprising reheating, recompressing, and recooling the build surface so as to cause the gap to diminish and the part region surface to become progressively stronger.

35. The method of any of claims 27-34, wherein the surface roughness of vertical part surfaces is less than 8 μm.
